(19) United States
(12) Patent Application Publication
(10) Pub. No.: US 2018/0309917 A1
(43) Pub. Date: Oct. 25, 2018

(54) MOBILE TERMINAL AND METHOD OF CONTROLLING THE SAME

(71) Applicant: LG ELECTRONICS INC., Seoul (KR)

(72) Inventors: Sangki KIM, Seoul (KR); Jihoon KIM, Seoul (KR)

(73) Assignee: LG ELECTRONICS INC., Seoul (KR)

(21) Appl. No.: 15/961,637

(22) Filed: Apr. 24, 2018

(30) Foreign Application Priority Data
Apr. 25, 2017 (KR) 10-2017-0052818

(51) Int. Cl. H04N 5/225; H04N 5/235

(52) U.S. Cl. CPC H04N 5/2258; H04N 5/2351

(57) ABSTRACT

A mobile terminal and a method of controlling the same are provided. The mobile terminal includes a first camera sensor; a second camera sensor; an illuminance sensor sensing an illuminance change on the periphery of the mobile terminal; and a controller controlling image shooting based on the first camera sensor, and controlling the second camera sensor to start the image shooting if the illuminance change sensed by the illuminance sensor is a threshold value or more.

### CROSS-REFERENCE TO RELATED APPLICATIONS

Pursuant to 35 U.S.C. § 119(a), this application claims the benefit of earlier filing date and right of priority to Korean Patent Application No. 10-2017-0052818, filed on Apr. 25, 2017, the contents of which are all hereby incorporated by reference herein in its entirety.

### BACKGROUND OF THE INVENTION

### Field of the Invention

The present invention relates to a mobile terminal and a method of controlling the same, and more particularly, to a method of processing camera sensor data in a mobile terminal provided with or connected with a plurality of cameras.

### Discussion of the Related Art

Terminals may be generally classified as mobile/portable terminals or stationary terminals according to their mobility. Mobile terminals have become increasingly more functional. As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device. There are ongoing efforts to support and increase the functionality of mobile terminals. Such efforts include software and hardware improvements, as well as changes and improvements in the structural components which form the mobile terminal.

The mobile terminal of the related art, which includes a plurality of cameras, may acquire images by controlling each camera. For example, in the mobile terminal of the related art, when a user shoots a video by using the plurality of cameras, it is difficult to separately control various events generated during the process of shooting a video, except details initially set to correspond to the various events. Therefore, if the user checks the video after shooting the video, an unwanted scene or a scene having a difference in quality from the other scenes may occur. In this case, although the quality may be compensated or calibrated using various filters or editing tools in some degree, there may be inconvenience. Even though the compensation or calibration is applied to the quality, the quality problem may still occur.

Particularly, when the video is shot frequently or for a long time through the mobile terminal, the above problem is likely to occur.

### SUMMARY OF THE INVENTION

Accordingly, the present invention is directed to a mobile terminal and a method of controlling the same, which substantially obviate one or more problems due to limitations and disadvantages of the related art.

An object of the present invention is to ensure or compensate (hereinafter, compensate), or improve quality of image data according to shooting using a plurality of, that is, at least two or more camera sensors or units (hereinafter, referred to as camera sensors) provided in a mobile terminal.

Another object of the present invention is to provide a mobile terminal that compensates or improves quality of shooting image by controlling an operation of a second camera sensor in accordance with event or factor (hereinafter, referred to as ‘factor’) such as frequency, brightness or illuminance change of a peripheral environment, which is sensed during a process of shooting an image using a first camera sensor.

Other object of the present invention is to provide convenience of a user and enhance reliability by adaptively performing image processing according to factor change at a position where the factor change is made or predicted, by using a shooting mode such as manual/automatic and indoor/outdoor.

Additional advantages, objects, and features of the specification will be set forth in part in the description which follows and in part will become apparent to those having ordinary skill in the art upon examination of the following or may be learned from practice of the specification. The objectives and other advantages of the specification may be realized and attained by the structure particularly pointed out in the written description and claims hereof as well as the appended drawings.

A mobile terminal and a method of controlling the same are disclosed in this specification.

To achieve these objects and other advantages and in accordance with the purpose of the specification, as embodied and broadly described herein, a mobile terminal according to the present invention comprises a first camera sensor; a second camera sensor; an illuminance sensor sensing an illuminance change on the periphery of the mobile terminal; and a controller controlling image shooting based on the first camera sensor, and controlling the second camera sensor to start the image shooting if the illuminance change sensed by the illuminance sensor is a threshold value or more.

According to the present invention, the following advantageous effects may be obtained.

According to at least one of various embodiments of the present invention, it is advantageous that quality of image data according to shooting using a plurality of, that is, at least two or more camera sensors or units (hereinafter, referred to as camera sensors) provided in a mobile terminal may be ensured or compensated (hereinafter, referred to as ‘compensated’) or improved.

According to at least one of various embodiments of the present invention, it is advantageous that the mobile terminal may compensate or improve quality of shooting image by controlling an operation of a second camera sensor in accordance with event or factor (hereinafter, referred to as ‘factor’) such as frequency, brightness or illuminance change of a peripheral environment, which is sensed during a process of shooting an image using a first camera sensor.

According to at least one of various embodiments of the present invention, it is advantageous that convenience of a user may be provided and reliability may be enhanced by adaptive image processing according to factor change at a position where the factor change is made or predicted, by using a shooting mode such as manual/automatic and indoor/outdoor.

According to at least one of various embodiments of the present invention, it will be appreciated by persons skilled in the art that that the effects that can be achieved through the present invention are not limited to what has been particularly described hereinabove and other advantages of the present invention will be more clearly understood from the following detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure;

FIGS. 1B and 1C are conceptual views of one example of the mobile terminal, viewed from different directions;

FIG. 2 is a conceptual view of a deformable mobile terminal according to an alternative embodiment of the present disclosure;

FIG. 3 is a conceptual view of a wearable mobile terminal according to another alternative embodiment of the present disclosure;

FIG. 4 is a rear perspective view illustrating a mobile terminal provided with a plurality of cameras according to one embodiment of the present invention;

FIG. 5 is a schematic block diagram illustrating camera sensors and their data processing according to one embodiment of the present invention;

FIG. 6 is a diagram illustrating a method for shooting an ultrahigh-speed image using a dual camera according to one embodiment of the present invention;

FIG. 7 is a diagram illustrating a method for processing image data acquired through a dual camera in accordance with one embodiment of the present invention;

FIG. 8 is a diagram illustrating contents related to exposure time acquisition in a dual camera according to one embodiment of the present invention;

FIGS. 9 to 11 are diagrams illustrating a coupling method of hetero-dual camera sensors for ultrahigh-speed video image according to one embodiment of the present invention;

FIG. 12 is a flow chart illustrating an image processing method of a mobile terminal through a dual camera sensor according to one embodiment of the present invention;

FIG. 13 is a diagram illustrating an image adaptive blending scheme according to one embodiment of the present invention;

FIG. 14 is a diagram illustrating occurrence of an event such as a change of peripheral illuminance according to the present invention;

FIGS. 15 to 18 are diagrams illustrating a frame insertion method based on peripheral illuminance according to the present invention; and

FIG. 19 is a flow chart illustrating a frame insertion method based on peripheral illuminance according to the present invention.

### DETAILED DESCRIPTION OF THE PREFERRED EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

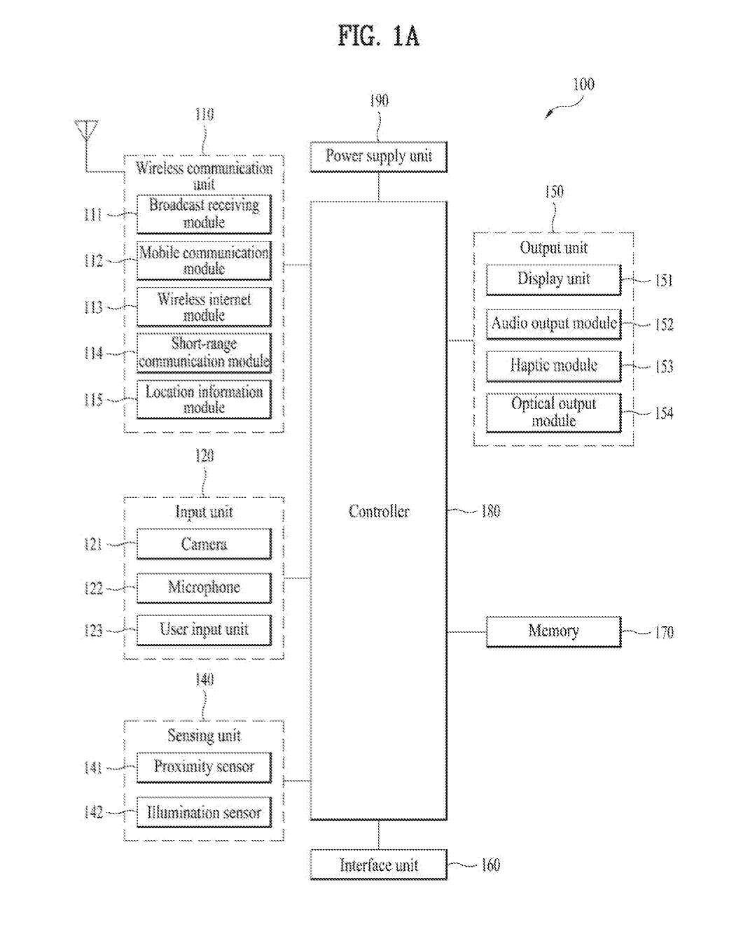

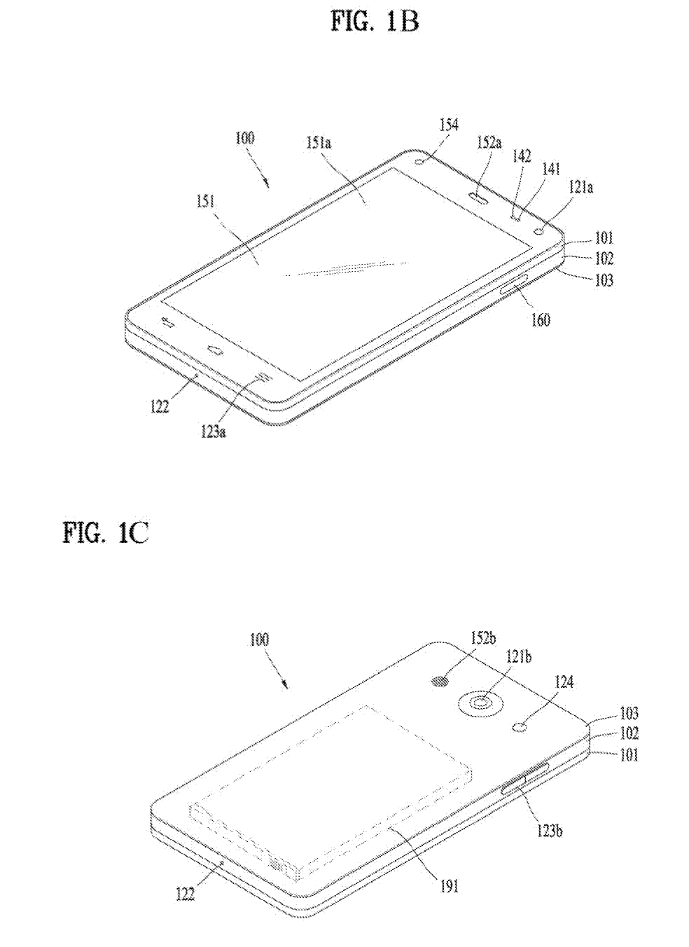

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact.

The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 3D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

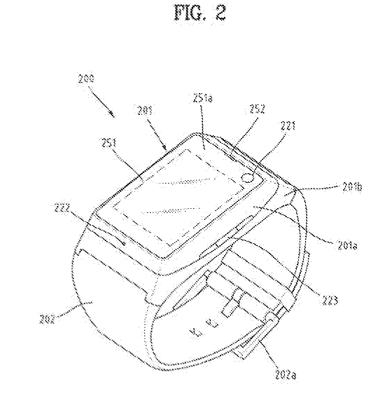

FIG. 2 is a conceptual view of a deformable mobile terminal according to an alternative embodiment of the present invention. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state(or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

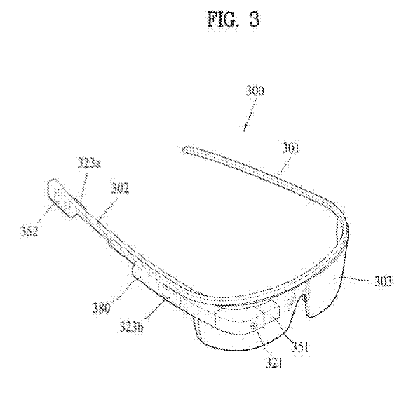

FIG. 3 is a perspective view illustrating one example of a watch-type mobile terminal 300 in accordance with another exemplary embodiment. As illustrated in FIG. 3, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

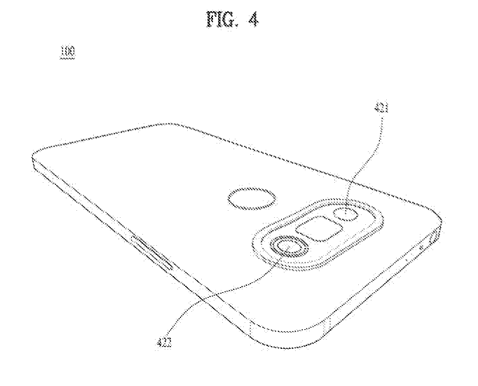

FIG. 4 is a rear perspective view illustrating a mobile terminal provided with a plurality of cameras according to one embodiment of the present invention.

The mobile terminal 100 may be comprised of a front surface and a rear surface. Generally, a display is provided on the front surface together with a touch screen. At least one camera and at least one of a function button and power on/off buttons may be provided on the rear surface. At least one of the function button and the power on/off buttons may be provided at a side of the mobile terminal 100 not the rear surface. However, the description related to the front surface, the rear surface and the side of the mobile terminal is only exemplary, and the present invention is not limited to such configuration, structure or arrangement.

Meanwhile, for convenience, FIG. 4 illustrates that a first camera 421 and a second camera 422 are formed on the rear surface of the mobile terminal 100 as an example.

The first camera 421 and the second camera 422 may be provided to be spaced apart from each other at a predetermined interval. In this case, as shown in FIG. 4, if the two cameras 421 and 422 spaced apart from each other at a predetermined interval are used at the same time, different images may be acquired from the same subject.

The two cameras 421 and 422 may have their respective pixels and view angles different from each other. For example, the first camera 421 may have a view angle of a narrow angle or a normal or standard angle while the second camera 422 may have a view angle of a wide angle, or vice versa. Hereinafter, the first camera 421 which has a view angle of a narrow angle or a normal or standard angle and the second camera 422 which has a view angle of a wide angle will be described.

Meanwhile, in this specification, the view angle means a range of a horizontal and vertical field of view (FOV) that may be included in a certain screen during shooting through a camera sensor. Other terms which are the same as or similar to the view angle may be used by being included in the scope of the present invention.

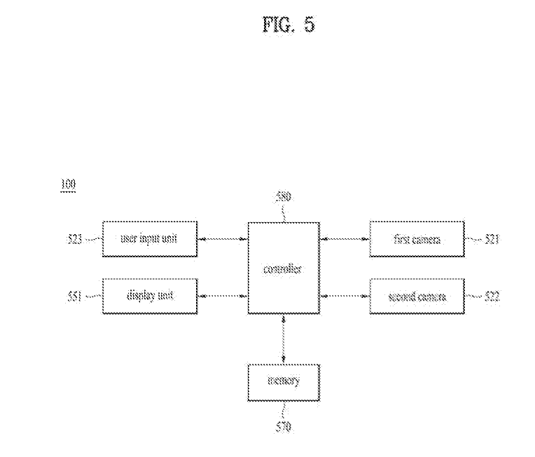

FIG. 5 is a schematic block diagram illustrating camera sensors and their data processing according to one embodiment of the present invention.

A first camera 521 and a second camera 522 may have their respective pixels and view angles different from each other as described with reference to FIG. 4. Also, although FIG. 4 illustrates that the first camera and the second camera are provided on the rear surface of the mobile terminal, the first camera and the second camera may be provided on the rear surface of the mobile terminal.

A user input unit 523 receives a signal for acquiring a first image and a second image. The signal for acquiring the images is a signal generated by a physical button (not shown) provided in the mobile terminal 100 or a touch input. If the signal for acquiring the images is a touch input for a shooting button, which is displayed on a display unit, the user input unit 523 and the display unit 551 may be configured as a single module and then operated. Meanwhile, it is to be understood that acquisition of the images means image shooting by means of a predetermined camera.

The display unit 551 displays a preview image through the first camera or the second camera. Also, the display unit 551 displays a predetermined shooting button for acquiring the images together with the preview image.

A memory 570 stores the images acquired by the first camera 521 and the second camera 522.

A controller 580 is coupled with the first camera 521, the second camera 522, the user input unit 523, the display unit 551, and the memory 551 to control each of them. Meanwhile, the controller 580 may correspond to the aforementioned controller 180 of FIG. 1a.

Hereinafter, for understanding of the present invention and convenience of description, a case that a camera application is executed in the mobile terminal or a plurality of camera sensors are turned on will be described as an example. Also, a case that video image is shot using a plurality of camera sensors provided in the mobile terminal will be described as an example. However, the present invention is not limited to the above examples. Hereinafter, in this specification, a plurality of camera sensors, particularly two camera sensors (or dual camera sensor) are used as an example, however, the present invention is not limited to this example.

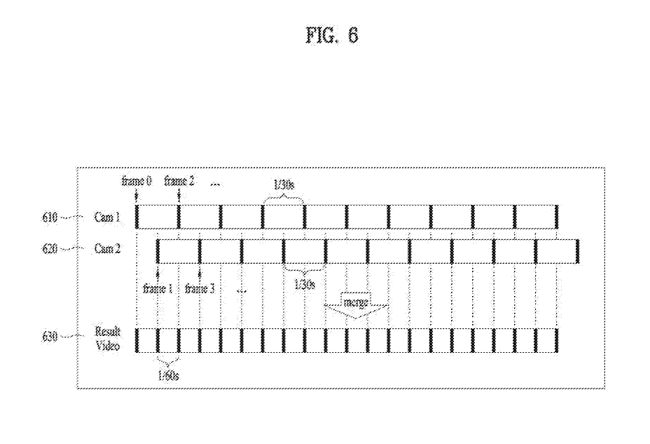

In this case, a method for shooting ultrahigh-speed video image using a dual camera will be described with reference to FIGS. 6 to 13.

Recently, a dual camera sensor is provided in the mobile terminal. Therefore, a new function, a user experience, etc. are required in accordance with this recent trend. First of all, a method for shooting ultrahigh-speed video through cross shooting using the plurality of camera sensors will be described.

Generally, a physical maximum frame rate of a camera sensor provided in a mobile terminal is restrictive. Therefore, if cross shooting is theoretically performed through a dual camera sensor, video having frame per second (FPS) of twice may be shot as compared with the case that a single camera sensor is used.

However, in addition to simple cross shooting, the dual camera sensor may generate softer ultrahigh-speed image through camera motion estimation and registration between images cross shot and acquired from the dual camera sensor.

Meanwhile, if ultrahigh-speed shooting is performed using a single camera sensor only, it is difficult to obtain a sufficient exposure time due to a read-out time relation of the corresponding camera sensor. Therefore, if cross shooting is performed using the dual camera, an exposure time of twice or more may be obtained, whereby ultrahigh-speed video shooting of high quality may be performed as compared with the single camera sensor.

Also, if a dual camera system of a wide angle camera and a narrow angle camera is adopted in the mobile terminal, a wide angle ultrahigh-speed video acquisition function of ultrahigh resolution may be performed through registration of a wide angle image and a narrow angle image.

For example, a corresponding portion of a wide angle image may be covered (or overlapped) with an image patch of high resolution of a main subject (panorama) shot by the narrow angle camera, through registration and motion estimation, whereby the wide angle image of high resolution may be generated.

In case of a wide angle image background corresponding to the outside of a narrow angle camera view, since a user is generally insensitive to deterioration of picture quality, resolution may be improved through at least one of motion estimation, up-sampling, etc.

FIG. 6 is a diagram illustrating a method for shooting an ultrahigh-speed image using a dual camera according to one embodiment of the present invention.

According to the method shown in FIG. 6, cross shooting may be performed using two camera sensors, each of which is 30 FPS, whereby video data of 60 FPS may be acquired.

Referring to FIG. 6, each of a first camera sensor Cam1 610 and a second camera sensor Cam2 620 may acquire video data of 1/30 s, that is, 30 FPS. At this time, data shot through the first camera sensor 610, that is, frames are acquired through shooting between frames by the second camera sensor 620 in the middle of shooting video through the first camera sensor 610 and then merged, whereby result video data of 60 FPS may be acquired theoretically. This may be referred to as frame doubling. In other words, in case of frame 0 to frame 3 in the result video frame 630, frame 0 and frame 2 are acquired through the first camera sensor 610, and fame 1 and frame 3 are acquired through the second camera sensor 620. That is, the merged result video frames 630 may be shot and configured such that frames acquired through different camera sensors may be arranged alternately, whereby ultrahigh-speed video image data may be acquired.

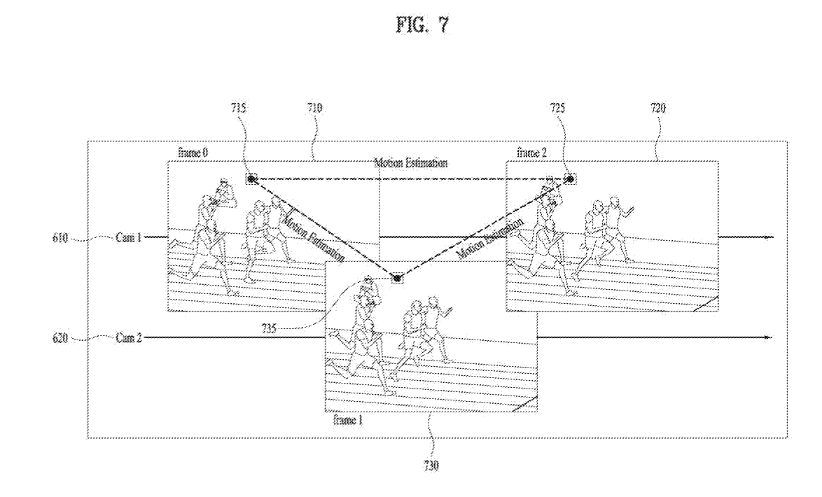

FIG. 7 is a diagram illustrating a method for processing image data acquired through a dual camera in accordance with one embodiment of the present invention.

Referring to FIG. 7, frame 0 710 and frame 2 720 acquired by the first camera sensor 610 are shown, and frame 1 730 acquired by the second camera sensor 620 is shown between the frame 0 710 and the frame 2 720. In this case, the frames acquired by the first camera sensor 610 and the second camera sensor 620 and their arrangement may depend on the aforementioned method of FIG. 6.

FIG. 7 may relate to a method for processing the result video 630 subsequently to FIG. 6 or in generating the result video 630 in FIG. 6.

For understanding of the present invention and convenience of description, the video frames acquired through the respective camera sensors in FIG. 6 are merged to acquire the result video 630 as follows.

The principle of FIG. 7 is basically based on that the first camera sensor 610 has a view angle different from that of the second camera sensor 620. In other words, if the first camera sensor 610 has the same view angle as that of the second camera sensor 620, even though the images acquired from the first and second camera sensors are merged, motion blur may be attenuated relatively. However, if the two camera sensors have their respective view angles different from each other in the same manner as a dual camera sensor adopted in the present invention, or the mobile terminal, various details such as frame size, absolute position of an object within the frame, etc. may be varied. In this case, if any one factor of them is only considered, a problem may occur due to another factor. Therefore, it may be required to merge the images by properly considering related factors.

For reference, in this specification, since the respective cameras have their respective view angles different from each other, it may be required to perform image processing for each frame acquired through each camera. Since video image has been described as an example of the present invention, image processing may be performed through a process such as motion estimation, compensation, etc. on the basis of an object within the frame acquired to be suitable for the video, whereby motion blur according to simple frame image merging may be avoided in advance.

Meanwhile, the object serves as a reference for motion estimation, compensation, etc., but the present invention is not limited to the object. For example, at least one absolute coordinate previously defined within the frame may be a reference point even without a specific object. Otherwise, at least two or more objects or reference points may be used to perform image processing such as motion estimation, compensation, etc. without using only one object or reference point, whereby accuracy in motion estimation, compensation, etc. may be enhanced. Otherwise, at least one object and at least one reference point may be used to perform motion estimation, compensation, etc.

Although three frames are shown in FIG. 7, the present invention is not limited to the example of FIG. 7. In other words, the number of frames for processing such as motion estimation, compensation, etc. for image processing according to the present invention is optional.

In addition, the image processing technology such as already known motion estimation, compensation, etc. or its modified technology may be applied to the image processing method such as motion estimation, compensation, etc. in respect of the present invention. Therefore, the image processing method according to the present invention may be understood with reference to the known technology and therefore its detailed description will be omitted.

In short, the images acquired from the respective camera sensors may be distorted in their center areas due to a difference in baseline of the dual camera sensor together with a difference in a view angle. This problem may be solved by a feature point based registration method in the present invention.

For example, as shown in FIG. 7, feature point motion between frames is estimated through matching of a plurality of feature points 715, 725 and 735 between adjacent frames shot by one camera sensor. Image may be calibrated by estimation of camera motion based on the first or second camera sensor from the estimated feature point motion. Meanwhile, if the subject is sufficiently far away, simple translation may only be performed through camera calibration information obtained by the product manufacturing step, for example.

In other words, the image processing method of FIG. 7 may be referred to as image registration.

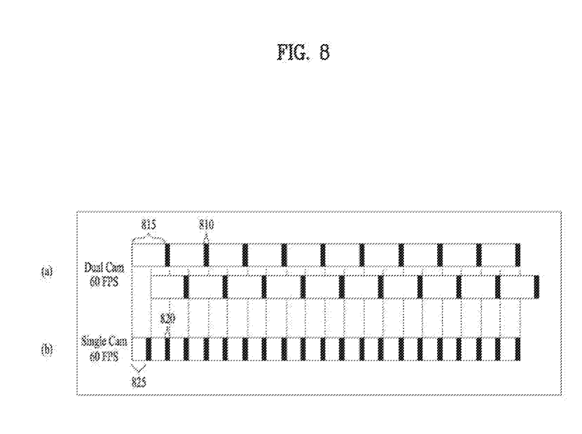

FIG. 8 is a diagram illustrating contents related to exposure time acquisition in a dual camera according to one embodiment of the present invention.

In this case, FIG. 8a illustrates that a dual camera sensor is provided, and FIG. 8b illustrates that a single camera sensor is provided. At this time, even though a plurality of camera sensors are provided in or connected to the mobile terminal, the case of FIG. 8b may include that image is shot through one of the plurality of camera sensors.

Meanwhile, for comparison between FIGS. 8a and 8b, it is assumed that a frame rate of final result video is equally applied to each of the dual camera and the single camera. Although a final result video frame through the dual camera of FIG. 8a is not shown, it is noted from FIG. 6 that the video frame of FIG. 8a is similar to that of FIG. 8b. For convenience, the assumed frame rate is 60 FPS as an example. However, the frame rate of the single camera sensor of FIG. 8b is 60 FPS, whereas the frame rate of each camera sensor of the dual camera sensor of FIG. 8a may be 30 FPS. In other words, in FIG. 8a, each of the first camera sensor and the second camera sensor has a frame rate of 30 FPS as described above. However, in case of the second camera sensor, frame is generated between the frames of the first camera sensor to finally obtain the same effect as that of 60 FPS.

Also, referring to FIGS. 8a and 8b, for more exact comparison of the exposure time, it is assumed that a readout time 810 of each frame in FIG. 8a is the same as a readout time 820 of each frame in FIG. 8b.

However, referring to FIGS. 8a and 8b, it is noted that a difference occurs between a maximum exposure time 815 of FIG. 8a and a maximum exposure time 825 of FIG. 8b even though the readout times 810 and 820 are the same as each other.

For example, if video is shot through the single camera of FIG. 8b, the maximum exposure time 825 is relatively shorter than the maximum exposure time 815 when video is shot through the dual camera of FIG. 8a.

In other words, referring to FIG. 8a, it is noted that each of the maximum exposure time of the first camera sensor and the maximum exposure time 815 of the second camera sensor in the dual camera is longer than the maximum exposure time 825 of the single camera sensor of FIG. 8b. The maximum exposure time may relatively be obtained with respect to each camera sensor due to a frame rate. That is, this is because that the result video of 60 FPS is generated by synthesis of each camera sensor of 30 FPS in the dual camera as compared with that the result video of 60 FPS is generated by the single camera sensor of FIG. 8b. Meanwhile, since the second camera sensor in FIG. 8a is implemented such that frame is generated between the frames of the first camera sensor, if it is assumed that a first frame of the second camera sensor is generated between first and second frames of the first camera sensor as shown, the maximum exposure time may be longer. That is, in this case, the maximum exposure time of the second camera sensor of FIG. 8a may be obtained to be longer than the maximum exposure time of the first camera sensor. For example, quality of the result video, that is, ultrahigh-speed video of high resolution may be acquired. Generally, as shown in FIG. 8b, although it is very difficult to obtain the sufficient exposure time due to the readout time set in each camera sensor, according to the present invention, the sufficient exposure time may be obtained in spite of the set readout time, whereby quality may be obtained.

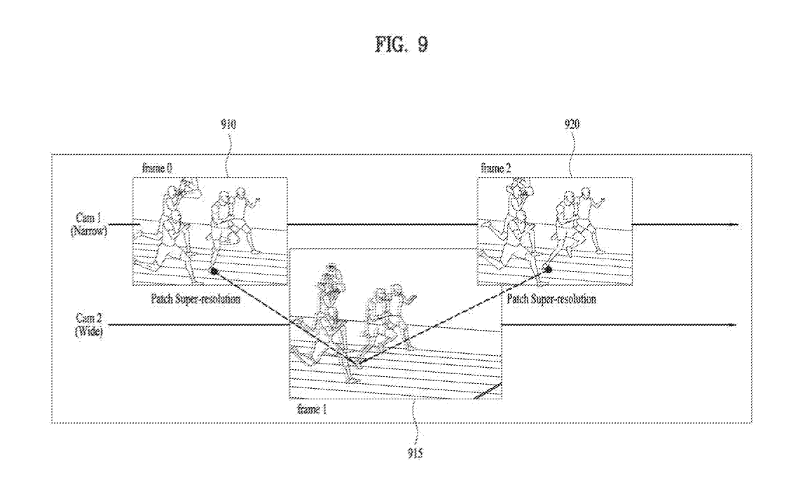

FIGS. 9 to 11 are diagrams illustrating a coupling method of hetero-dual camera sensors for ultrahigh-speed video image according to one embodiment of the present invention.

In FIG. 9, ultrahigh-speed video is shot by the dual camera sensor, that is, the first camera sensor Cam1 and the second camera sensor Cam2. In this case, the first camera sensor has a relatively narrow view angle, and the second camera sensor has a relatively wide view angle. Therefore, it is noted from FIG. 9 that the 0th frame 910 to the second frame 920 acquired by the narrow angle of the first camera sensor are different from the first frame 915 acquired by the wide angle of the second camera sensor.

If the videos or image frames acquired by the camera sensors having their respective view angles different from each other are simply synthesized, their objects or reference points may be twisted from each other, whereby distortion may occur in accordance with synthesis. Therefore, it is preferable to consider other factors such as view angle in synthesizing the images in accordance with the present invention. To this end, in this specification, a super-resolution method may be used for coupling of the hetero-dual camera sensor according to the present invention. However, in respect of coupling of the hetero-dual camera sensor, the super-resolution method for image synthesis is only one embodiment according to the present invention, and the scope of the present invention is not limited to the super-resolution method.

For example, referring to FIG. 9, the reference point is first set, and a point corresponding to the reference point within the 0th frame 910 and the second frame 920 acquired by the narrow angle of the first camera sensor and the reference point within the first frame 915 acquired by the wide angle of the second camera sensor is used as the reference point during image synthesis to perform patch super-resolution, whereby the aforementioned problem may be solved.

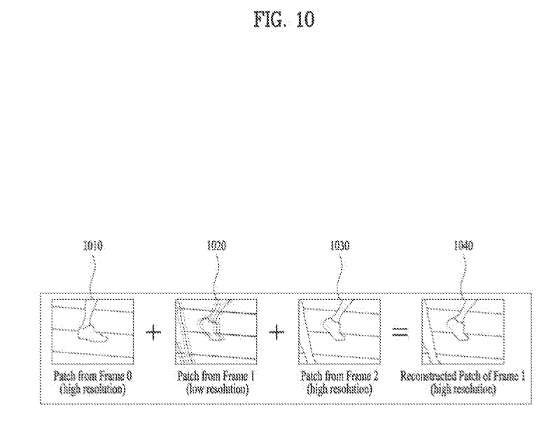

Description will be given in more detail with reference to FIG. 10. A first patch 1010 acquired from the 0th frame 910, a second patch 1020 acquired from the first frame 915 and a third patch 1030 acquired from the second frame 920 are subjected to super-resolution, whereby a reconstructed patch 1040 of the first frame 915 may be acquired finally. In this case, since the first patch 1010 and the third patch 1030 are acquired from the first camera sensor 910 having a narrow angle, the first and third patches may have high resolution. Since the second patch 1020 is acquired from the second camera sensor 920 having a wide angle, the second patch may have low resolution as compared with the first and third patches. However, the final patch, that is, the reconstructed patch 1040 may be acquired to have high resolution through image synthesis based on super-resolution of the above patches.

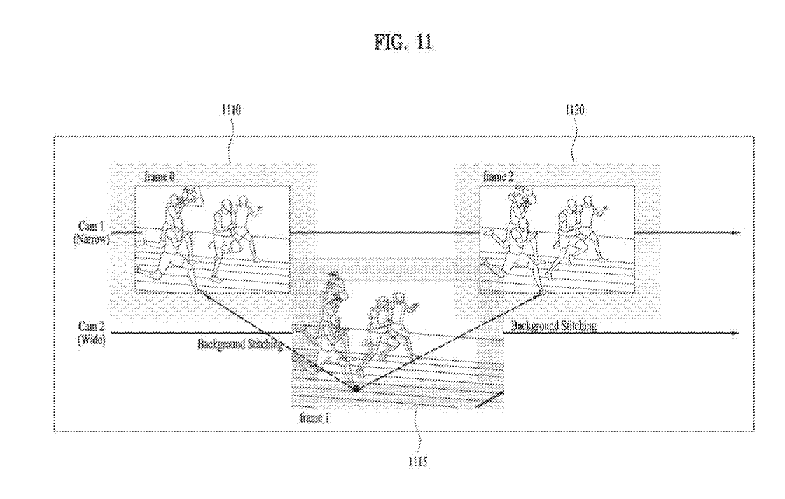

Next, another embodiment of the coupling method of the hetero-dual camera sensor will be described with reference to FIG. 11.

Even though the camera sensor of a narrow angle and the camera sensor having a wide angle, which are provided in or connected to the mobile terminal, are used, a high-speed camera function may be implemented using two different camera sensors. However, in this case, since a difference in a view angle also occurs in addition to a difference in a baseline between the two cameras, a difference in a field of view (FOV), resolution, etc. of images shot by the cameras may occur.

For example, the narrow angle camera sensor may shoot a main subject at high resolution (using an optical image stabilizer (OIS), etc.), whereas the wide angle camera sensor may obtain a wide background image which is not seen by the narrow angle camera sensor.

The aforementioned image registration and local patch based super-resolution method are used for an area of the main subject, whereby resolution of image of the wide angle camera may be improved to a level of the narrow angle camera as shown in FIG. 9.

Meanwhile, in FIG. 10, considering that the general super-resolution method obtains image of high resolution from a plurality of images of low resolution and local patch is little changed, restoration of image resolution of the wide angle camera to resolution of the narrow angle camera using image of high resolution of adjacent narrow angle camera frames and a wide angle camera frame of a current frame may be implemented more stably than the general super-resolution method.

Also, in case of background not the main subject, the user is less sensitive to resolution of the background. Using this, a background 1115 of the adjacent wide angle camera frames is stitched to backgrounds 1110 and 1120 of the corresponding narrow angle camera frame as shown in FIG. 11, whereby a view angle of the narrow angle camera frame may be enlarged.

Meanwhile, although not shown in this specification, FIGS. 9 and 10 may be combined with FIG. 11, whereby another embodiment may be implemented.

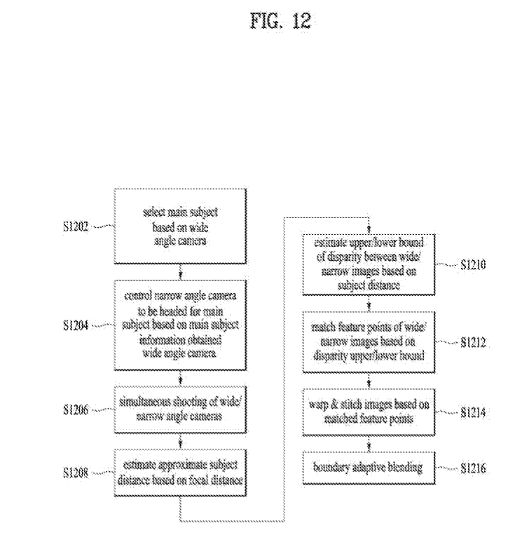

Next, FIG. 12 is a flow chart illustrating an image processing method of a mobile terminal through a dual camera sensor according to one embodiment of the present invention.

Recently, a dual camera is used as a camera sensor in the mobile terminal. Therefore, as described above, it is required to provide a user experience different from the existing user experience or various user experiences in accordance with adoption of the dual camera.

The high resolution wide angle image shooting technology through simultaneous shooting of two camera sensors of a wide angle and a narrow angle will be described as follows. In this case, the same portion as the aforementioned description or a portion to which the aforementioned description is applicable may be used as it is.

Since a wide angle image should cover a wide view angle within limited resolution, loss of resolution may occur in a main subject area. Therefore, to solve this problem, according to the present invention, a wide angle image of high resolution may be acquired through image registration of a wide angle image and a narrow angle image.

Meanwhile, a high resolution image patch of a main subject (panorama) shot by the narrow angle camera may be stitched to a corresponding portion of the wide angle image through disparity estimation and registration, whereby a wide angle image of high resolution may be generated.

Also, with respect to a background corresponding to the outside of a narrow angle camera view, since a user is generally insensitive to deterioration of picture quality, even though resolution is enhanced through up-sampling, a problem of image quality may not occur.

This will be described in more detail with reference to FIG. 12.

First of all, the mobile terminal selects a main subject based on the wide angle camera (S1202). In this case, in respect of selection of the main subject, the mobile terminal may select one of a selection area of the user, a focus area of the user, an estimation area and a center area as the main subject. However, for convenience, when the main subject is selected, it may be determined that the focus area and the estimation area may be prior to the center area, and the user selection area may be prior to the focus area and the estimation area.

Afterwards, the narrow angle camera is controlled based on main subject information acquired from the wide angle camera, whereby the narrow angle camera is headed for the main subject (S1204). At this time, information on focal distance and direction may be used to control the narrow angle camera, and especially OIS data may be used for the information on direction.

Afterwards, the mobile terminal may simultaneously shoot an image through the wide angle camera and the narrow angle camera (S1206).

Also, the mobile terminal may estimate an approximate distance of the subject based on a focal distance of the shot image (S1208).

The mobile terminal estimates upper and lower bounds of disparity between wide and narrow angle images based on the distance of the subject (S1210).

The mobile terminal matches feature points of wide and narrow angle images on the basis of the estimated disparity upper or lower bound (S1212).

Images (videos) are warped or/and stitched based on the matched feature points (S1214).

Afterwards, the mobile terminal performs adaptive blending for a boundary portion (S1216).

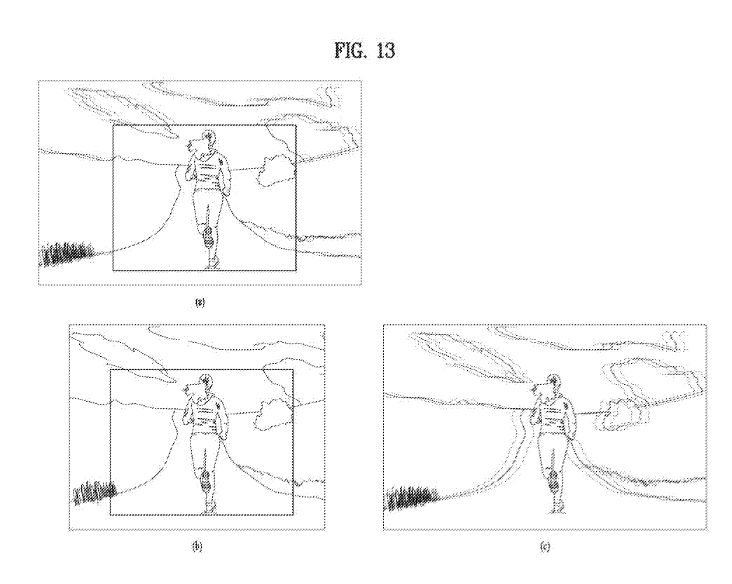

FIG. 13 is a diagram illustrating an image adaptive blending scheme according to one embodiment of the present invention.

FIG. 13a illustrates that a narrow angle image (inside) 1310 of high resolution based on the first camera sensor and an image (outside) 1320 of low resolution based on the second camera sensor are stitched. In this case, the image of low resolution may have resolution of ¼ of the narrow angle area as compared with the narrow angle area of high resolution. However, the present invention is not limited to this case.

Meanwhile, a background area from an original image of high resolution based on the first camera sensor may be restored through the aforementioned method after a wide angle image of low resolution and a narrow angle image of original resolution are generated randomly.

FIGS. 13b and 13c illustrates that an original image of high resolution, a background image of low resolution and a center image of high resolution are stitched. A background area from the original image of high resolution may be restored through the aforementioned method after a wide angle image of low resolution and a narrow angle image of original resolution are generated randomly.

Hereinafter, if at least two camera sensors (hereinafter, referred to as dual sensor like the aforementioned embodiment) are provided in or connected to the mobile terminal, a frame rate of the second camera sensor is changed or controlled (hereinafter, referred to as controlled) during the shooting process through the first camera sensor. At this time, there may be various factors for controlling the frame rate of the second camera sensor. Hereinafter, various camera sensor factors such as peripheral illuminance, frequency, brightness change, etc. will be described as examples. However, the present invention is not limited to these factors.

In short, the frame rate of the second camera sensor is changed or controlled in accordance with occurrence of event such as a change of peripheral illuminance during shooting through the first camera sensor of the mobile terminal, whereby quality of the acquired image may have no problem or may be compensated.

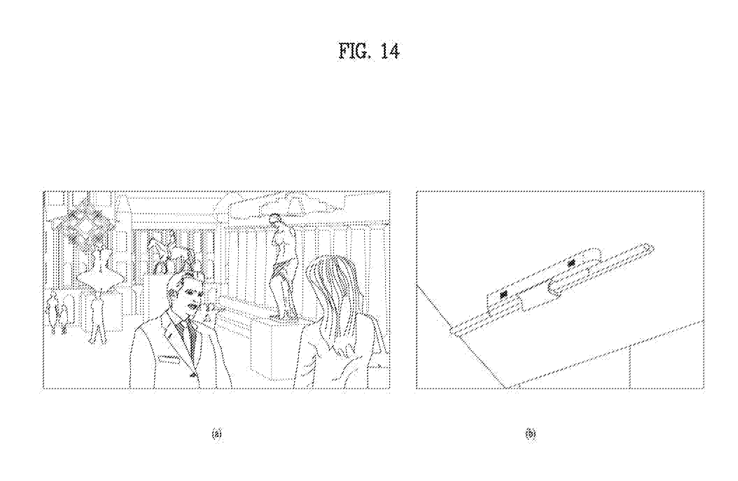

FIG. 14 is a diagram illustrating occurrence of an event such as a change of peripheral illuminance according to the present invention.

FIG. 14a illustrates that a user of the mobile terminal is located outdoor. In this case, illuminance is affected by solar light. In other words, if the user is located outdoor, since solar light is almost uniformly maintained as far as there is no rapid change of weather or there is no natural disaster such as flare of sunspot, illuminance event is less likely to occur.

On the other hand, FIG. 14b illustrates that a user of the mobile terminal is located indoor. In this case, it is general that an artificial means, that is, a lamp device such as fluorescent lamp and LED is used instead of natural light. However, if the user takes a picture or video in an indoor space where the lamp device is used, through an image-pickup device such as the mobile terminal, it is noted that the acquired image is affected by illuminance change due to frequency, etc. although not seen by the naked eye. Therefore, although not shown, distortion such as stripe or blur image may be included in the acquired image.

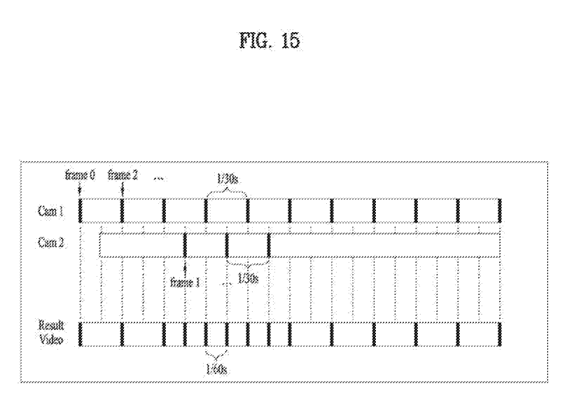

In the present invention, the aforementioned problem may be solved using methods described later with reference to FIGS. 15 to 18. However, in describing this embodiment, repeated description of the aforementioned embodiment depends on the aforementioned description, and will be omitted.

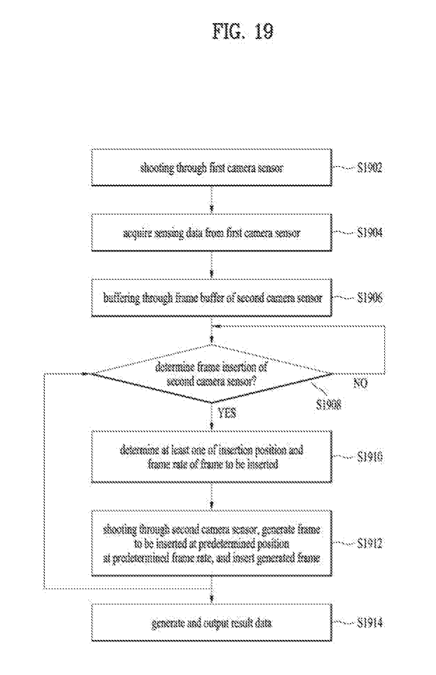

FIGS. 15 to 18 are diagrams illustrating a frame insertion method based on peripheral illuminance according to the present invention, and FIG. 19 is a flow chart illustrating a frame insertion method based on peripheral illuminance according to the present invention.

Hereinafter, for understanding of the present invention and convenience of description, the image processing method or image shooting method according to the peripheral illuminance will be described based on, but not limited to, the frame insertion method as an example. For example, as the other methods, the aforementioned synthesis method may be used, and combination and various methods may be used.

If a camera application is executed in the mobile terminal, the mobile terminal may shoot image. At this time, the camera application may be executed by a request of a user, etc.

The mobile terminal shoots an image through the first camera sensor (S1902). At this time, although the second camera sensor may also be operated, for convenience, the second camera sensor is buffered using a frame buffer and has a sufficient exposure time.

The mobile terminal acquires sensing data through the first camera sensor if image shooting starts in the first camera sensor (S1904). In this case, the first camera sensor may be an illuminance sensor, for example. However, the first camera sensor is not limited to the illuminance sensor, and the illuminance sensor will be described herein as an example to detect a change of peripheral illuminance. Meanwhile, although only illuminance is described as a factor, if a plurality of factors are used, the step S1904 may be performed prior to the step S1902 in accordance with the system according to the plurality of factors. In this case, after the second camera sensor is activated based on the sensing data of the first camera sensor and then is ready to shoot an image, the second camera sensor may generate frame data to be inserted through image shooting together with the first camera sensor as the case may be or after a predetermined time.

Meanwhile, the second camera sensor of the mobile terminal may include a frame buffer or may be arranged at a front end, and if the first camera sensor starts to shoot an image, the second camera sensor may perform buffering through the frame buffer (S1906). This buffering is intended to allow the second camera sensor to determine frame insertion in accordance with an illuminance change (or frequency change) in the present invention.

The controller of the mobile terminal determines whether frame insertion is performed through the second camera sensor (S1908). The controller may determine the frame insertion by determining whether there is an illuminance change (frequency change) from sensing data of the illuminance sensor or the illuminance change is a threshold value or more that may affect quality of acquired image.

If it is determined, through the second camera sensor, that frame insertion is required, the controller of the mobile terminal determines at least one of a frame insertion position and a frame rate of the frame to be inserted (S1910).

The second camera sensor performs shooting to generate a frame to be inserted to a predetermined positon at a predetermined frame rate under the control of the controller and inserts the generated frame (S1912).

The mobile terminal finally generates result data and then outputs the generated result data (S1914).

The frame insertion method will be described in more detail with reference to FIGS. 15 to 18.

Referring to FIG. 15, the image frame shot by the first camera sensor is 30 FPS and continues to be generated. At this time, although not shown, if there is illuminance change between frame 0 and frame 10 and the mobile terminal detects the illuminance change, as shown in FIG. 15, the second camera sensor may generate additional frame and insert the generated frame between frame 4 and frame 6, between frame 6 and frame 8 and between frame 8 and frame 10. At this time, the second camera sensor may be, but not limited to, 30 FPS in the same manner as the first camera sensor. Therefore, there may be different frame rates between frame 4 and frame 10 based on the frame shot by the first camera sensor. For example, in FIG. 15, there may be a frame rate of 60 FPS between frame 4 and frame 10 unlike frame rate of 30 FPS.

For example, FIG. 15 may relate to processing of an illuminance change between continuous those of frames generated by the first camera sensor. At this time, although an actual illuminance change may occur in a single frame, processing according to the illuminance change may be performed preferably in such a manner that frame is inserted to at least one of front and rear frames of the corresponding frame.

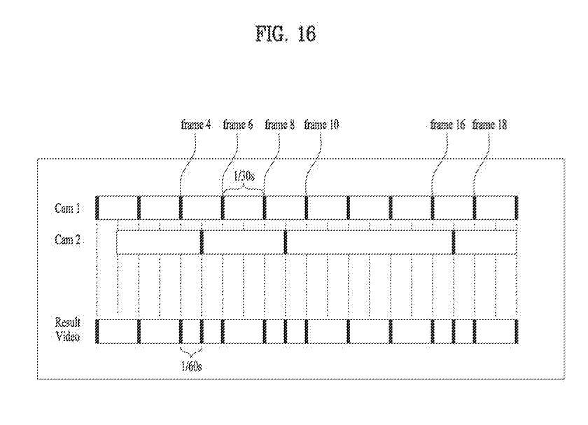

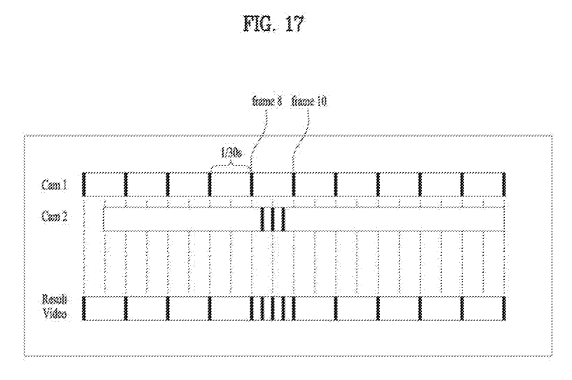

On the other hand, FIG. 16 may relate to processing when an illuminance change occurs in discontinuous frames based on frames generated by the first camera sensor.

Referring to FIG. 16, the frame acquired through the second camera sensor is inserted between frame 4 and frame 6, between frame 8 and frame 10, and between frame 16 and frame 18 in accordance with occurrence of the illuminance change.

In FIGS. 15 and 16, it is assumed that only one frame is inserted between frames generated by the first camera sensor.

On the other hand, unlike FIGS. 15 and 16, FIGS. 17 and 18 illustrate that the number of frames inserted between frames may be 2 or more. For example, FIG. 17 illustrates that the number of frames generated and inserted between frame 8 and next frame, that is, frame 10 is 3. In this way, the number of inserted frames and a frame rate of each inserted frame may be determined in accordance with a set condition or considering various factors such as a request of a user with respect to quality and peripheral conditions, and may be determined automatically through learning of the user's habit and intention.

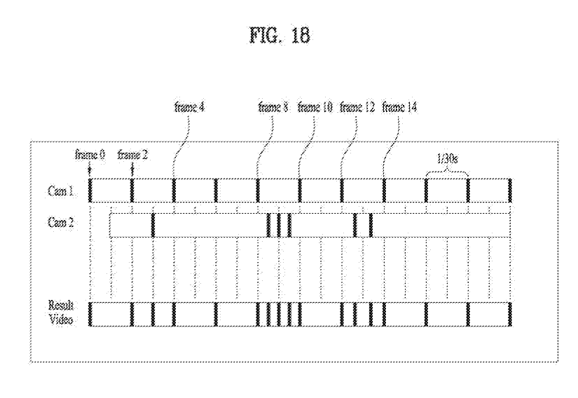

FIG. 18 also illustrates that a plurality of insertion frames may exist between a specific frame and next frame. However, unlike FIGS. 15 to 17, FIG. 18 illustrates that the number of frames inserted between frames constituting one image may not be always fixed.

For example, the number of frame inserted between frame 2 and frame 4 is 1, the number of frames inserted between frame 8 and frame 10 is 3, and the number of frames inserted between frame 12 and frame 14 is 2. In this way, the number of frames generated by the second camera sensor and inserted between one frame and next or adjacent frame may not be always fixed. For example, since the number of frames may be changed depending on at least one of various camera sensor factors such as a level of illuminance change between frames, background, OIS, and an exposure level, the number of frames is determined in accordance with the level of illuminance change sensed through the illuminance sensor. The number of insertion frames according to the level of the illuminance change may be defined in the form of table in accordance with the system.

As described above, according to at least one of various embodiments of the present invention, it is advantageous that quality of image data according to shooting using a plurality of, that is, at least two or more camera sensors or units provided in the mobile terminal may be ensured or compensated, or improved. The mobile terminal may compensate or improve quality of shooting image by controlling the operation of the second camera sensor in accordance with event or factor such as frequency, brightness or illuminance change of a peripheral environment, which is sensed during a process of shooting image using the first camera sensor. Convenience of a user may be provided and reliability may be enhanced by adaptive image processing according to factor change at a position where the factor change is made or predicted, by using a shooting mode such as manual/automatic and indoor/outdoor.

Although the terms used in this specification are selected from generally known and used terms considering their functions in the present specification, the terms may be modified depending on intention of a person skilled in the art, practices, or the advent of new technology.

The present invention described above may be implemented in a recording medium in which a program is recorded, as a code that can be read by a computer. The recording medium that can be read by the computer includes all kinds of recording media in which data that can be read by a computer system are stored. Examples of the recording medium include HDD (Hard Disk Drive), SSD (Solid State Disk), SDD (Silicon Disk Drive), ROM, RAM, CD-ROM, a magnetic tape, a floppy disk, and an optical data memory. Also, another example of the recording medium may be implemented in a shape of carrier wave (transmission through Internet). Also, the computer may include a controller of a wearable device. Thus, the above embodiments are to be considered in all respects as illustrative and not restrictive. The scope of the invention should be determined by reasonable interpretation of the appended claims and all change which comes within the equivalent scope of the specification are included in the scope of the invention.

Various modifications and variations can be made in the present invention by persons skilled in the art within spirits and scope of the present invention, and are included in the gist and range of the present invention defined in the accompanying claims.

What is claimed is:

1. A mobile terminal comprising:
a first camera sensor capturing information;
a second camera sensor capturing information;
an illuminance sensor sensing a change in illuminance on a periphery of the mobile terminal; and
a controller controlling the second camera sensor to capture images based on information captured by the first camera sensor such that the second camera sensor is controlled to start image capture when the sensed change in illuminance is at least a threshold value.

2. The mobile terminal according to claim 1, wherein the second camera sensor includes a frame buffer for performing frame buffering.

3. The mobile terminal according to claim 1, wherein the controller controls the second camera sensor to capture at least one second image frame for a time duration between an image frame in which the change in illuminance is sensed and at least one adjacent first image frame captured by the first camera sensor.

4. The mobile terminal according to claim 3, wherein the controller generates a result image by inserting the captured at least one second image frame between the image frame in which the change in illuminance is sensed and the at least one adjacent first image frame.

5. The mobile terminal according to claim 4, wherein the controller determines an insertion position of the captured at least one second image frame o, a number of the captured at least one second image frame to be inserted, and a frame rate of the captured at least one second image frame to be inserted.

6. The mobile terminal according to claim 5, wherein the controller determines the insertion position, the number of the captured at least one second image frame and the frame rate based on the sensed change in illuminance.

7. The mobile terminal according to claim 4, wherein the controller determines at least a number of the captured at least one second image frame to be inserted or a frame rate on the captured at least one second image frame to be inserted based on the sensed change in illuminance.

8. The mobile terminal according to claim 3, wherein the controller controls the second camera sensor to capture the at least one second image frame after a maximum exposure time of the second camera sensor.

9. The mobile terminal according to claim 1, wherein the controller controls at least the first camera sensor or the second camera sensor such that a frame rate of an image frame captured by the second camera sensor is different from a frame rate of an image frame captured by the first camera sensor.

10. The mobile terminal according to claim 1, wherein the first camera sensor has a wider view angle than the second camera sensor.
